(19) United States
(12) Patent Application Publication
(10) Pub. No.: US 2009/0024520 A1
(43) Pub. Date: Jan. 22, 2009

(54) Detection of Check Fraud Using Multiple Check Images

(76) Inventors: Tal Drory, Haifa (IL); Yaakov Navon, Ein Vered (IL)

Correspondence Address: IBM CORPORATION, T.J. WATSON RESEARCH CENTER, P.O. BOX 218, YORKTOWN HEIGHTS, NY, 10598, US

(21) Appl. No.: 11/778,671

(22) Filed: Jul. 17, 2007

(51) Int. Cl. G06Q 20/00

(52) U.S. Cl. 705/40; 382/137; 382/139

(57) ABSTRACT

A system and method for determining the validity of a check, the method including receiving from a payer an image of a check to a payee together with a personal identifier identifying the payer, where the payer is a customer of a financial institution, determining an account to which the check pertains, comparing the received personal identifier with a personal identifier maintained by the financial institution for the account, comparing the payer check image with an image of the check produced after the payee receives the check from the payer, designating the check as valid if the personal identifiers are the same and if the check images match within a predefined tolerance, and designating the check as invalid if the personal identifiers are not the same or if the check images do not match within a predefined tolerance.

### FIELD OF THE INVENTION

The present invention relates to bank check security in general, and more particularly to bank check fraud detection.

### BACKGROUND OF THE INVENTION

Check fraud poses a serious challenge to banks and their customers. With the advancement of technology it has become increasingly easy for criminals to manipulate checks, causing loss to individuals, businesses, and financial institutions. Checks can be stolen and falsely endorsed, or altered using chemicals and solvents that remove the original handwriting and information on the check. Using desktop publishing equipment, counterfeit checks can be created, and real checks can be copied.

One solution is to imbue checks with security features such as using special paper with watermarks and holograms. Although these features make it more difficult to copy a check or create a counterfeit check, they don't protect against theft or manipulation of a legitimate check.

### SUMMARY OF THE INVENTION

The present invention provides systems and methods for detecting bank check fraud.

In one aspect of the present invention a method is provided for determining the validity of a check, the method including receiving from a payer an image of a check to a payee together with a personal identifier identifying the payer, where the payer is a customer of a financial institution, determining an account to which the check pertains, comparing the received personal identifier with a personal identifier maintained by the financial institution for the account, comparing the payer check image with an image of the check produced after the payee receives the check from the payer, designating the check as valid if the personal identifiers are the same and if the check images match within a predefined tolerance, and designating the check as invalid if the personal identifiers are not the same or if the check images do not match within a predefined tolerance.

In another aspect of the present invention the receiving step includes receiving the payer check image via a Multimedia Message Service (MMS).

In another aspect of the present invention the determining step includes utilizing Magnetic Ink Character Recognition (MICR) data on the check to identify the account.

In another aspect of the present invention the comparing images step includes utilizing MICR data on the images to pair the images for comparison where the MICR data on the images match.

In another aspect of the present invention the method further includes maintaining check layout information for checks in the possession of the payer.

In another aspect of the present invention the method further includes utilizing MICR data on the check to retrieve the check layout information of the check, and identifying specific areas on the check in support of an area-by-area comparison between the images.

In another aspect of the present invention the method further includes receiving a personal identifier identifying the payee, where the payee personal identifier is received together with the image of the check produced after the payee receives the check from the payer.

In another aspect of the present invention a system is provided for determining the validity of a check, the system including means for receiving from a payer an image of a check to a payee together with a personal identifier identifying the payer, where the payer is a customer of a financial institution, means for determining an account to which the check pertains, means for comparing the received personal identifier with a personal identifier maintained by the financial institution for the account, means for comparing the payer check image with an image of the check produced after the payee receives the check from the payer, means for designating the check as valid if the personal identifiers are the same and if the check images match within a predefined tolerance, and means for designating the check as invalid if the personal identifiers are not the same or if the check images do not match within a predefined tolerance.

In another aspect of the present invention a check image checking system is provided including a check scanner configured to produce a scanned image of a check, a MICR reader configured to read MICR data from either of the check and an image of the check, a check image pairer configured to pair a check image received from a payor with an image of the check after it is given to a payee, a check image checker configured to check the paired images to determine whether the check images match, and an identification checker configured to check a personal identifier received with any of the check images against a store personal identifier.

In another aspect of the present invention a computer program is provided embodied on a computer-readable medium, the computer program including a first code segment operative to receive from a payer an image of a check to a payee together with a personal identifier identifying the payer, where the payer is a customer of a financial institution, a second code segment operative to determine an account to which the check pertains, a third code segment operative to compare the received personal identifier with a personal identifier maintained by the financial institution for the account, a fourth code segment operative to compare the payer check image with an image of the check produced after the payee receives the check from the payer, a fifth code segment operative to designate the check as valid if the personal identifiers are the same and if the check images match within a predefined tolerance, and a sixth code segment operative to designate the check as invalid if the personal identifiers are not the same or if the check images do not match within a predefined tolerance.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a check validation system, constructed and operative in accordance with an embodiment of the present invention;

FIGS. 2A and 2B are simplified flowchart illustrations of an exemplary method of operation of the system of FIG. 1, operative in accordance with an embodiment of the present invention; and

FIG. 3 is a simplified conceptual illustration of a check validation system, constructed and operative in accordance with another embodiment of the present invention.

FIG. 4, which is a simplified block diagram of a check image checking system, constructed and operative in accordance with an embodiment of the present invention.

### DETAILED DESCRIPTION OF THE INVENTION

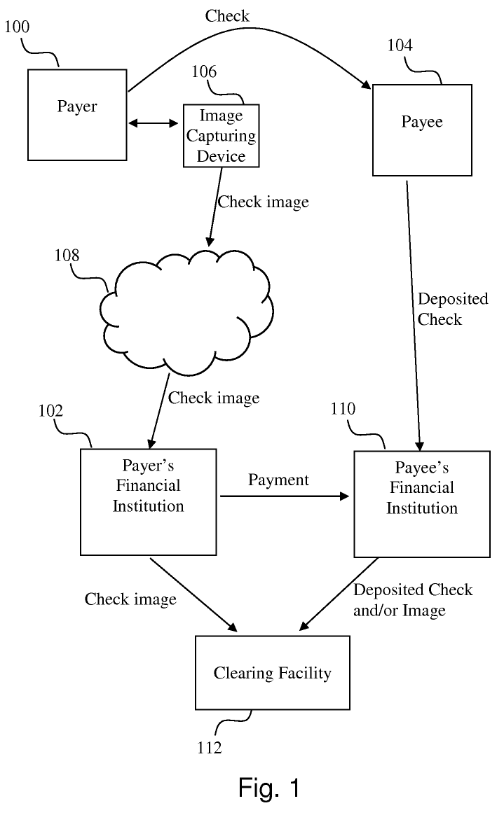

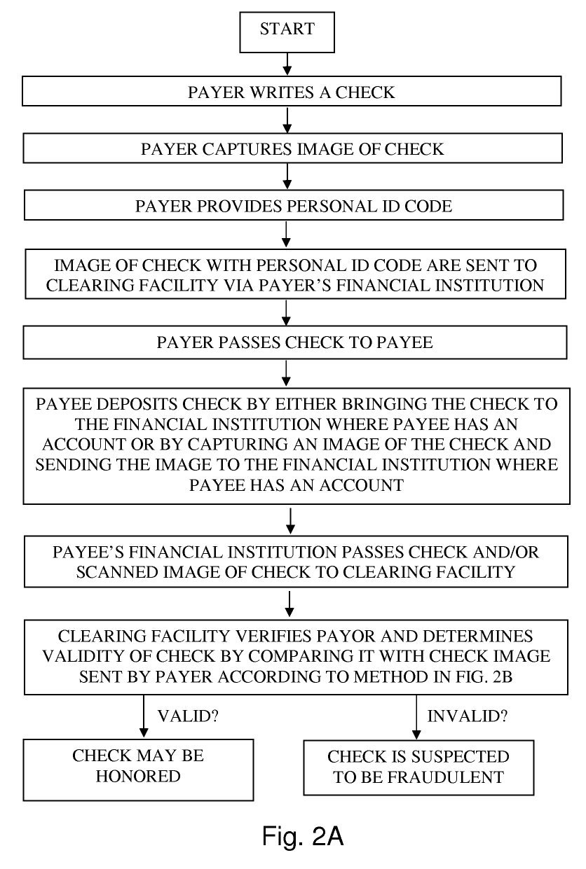

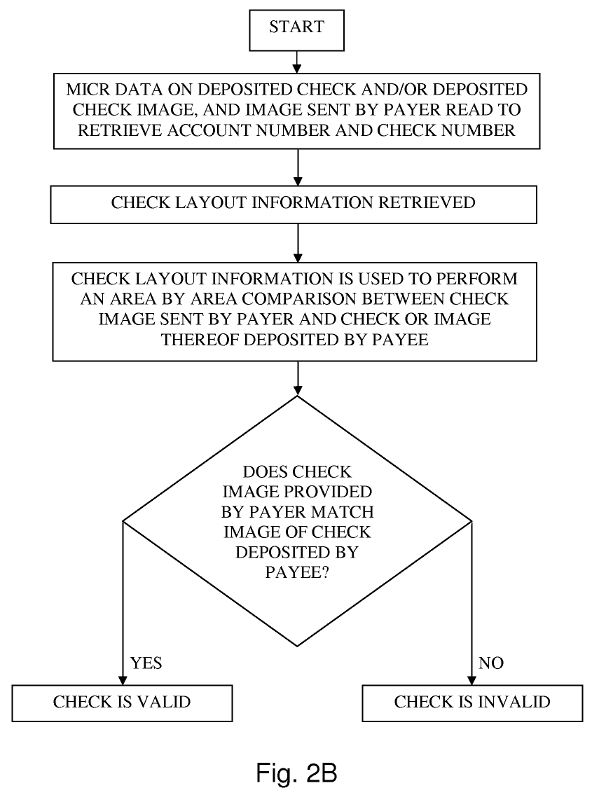

Reference is now made to FIG. 1, which is a simplified conceptual illustration of a check validation system, constructed and operative in accordance with an embodiment of the present invention, and additionally to FIGS. 2A and 2B, which are simplified flowchart illustrations of an exemplary method of operation of the system of FIG. 1, operative in accordance with an embodiment of the present invention. In the system of FIG. 1 and method of FIGS. 2A and 2B a payer 100 writes a check ordering the disbursement of funds from a financial institution 102 where payer 100 has an account. Prior to payer 100 giving the check to a payee 104, payer 100 captures the image of the check using an image capturing device 106, such as a cellular telephone camera. Payer 100 also preferably provides a personal identifier, such as by keying it into device 106, or by having device 106 read it from a Radio-frequency identification (RFID) tag that is known by financial institution 102 to identify payer 100. The personal identifier is preferably designated by financial institution 102 to be associated with payer 100 and/or a specific account of payer 100. The image of the check is then sent, with the personal identifier where provided, to financial institution 102 by conventional means, such via as a Multimedia Message Service (MMS) 108 or via a network such as the Internet. Financial institution 102 then preferably provides the check image and the personal identifier to a clearing facility 112, which may be internal to or separate from financial institution 102. Alternatively, payer 100 may send the check image, with the personal identifier where provided, directly to clearing facility 112, or to both financial institution 102 and clearing facility 112, if so directed by financial institution 102.

Payer 100 then passes the check to payee 104. Payee 104 then submits the check for redemption, such as by depositing the check with financial institution 110 where payee 104 has an account, preferably together with a personal identifier such as using the methods described hereinabove. Financial institution 110 then passes a scanned image of the check to clearing facility 112 and/or passes the check to clearing facility 112 where an image of the check may then be made.

The Magnetic Ink Character Recognition (MICR) data on all checks and/or check images received by clearing facility 112 are read using conventional automated techniques or are manually provided. The MICR data may be used to identify a related account and the account holder's personal identifier that may be maintained by financial institution 102 and/or clearing facility 112. The account holder's personal identifier may then be compared with the personal identifier received with the related check image. Matching personal identifiers may be used as verification that the check image came from the account holder. Similarly, where the payee's personal identifier is received during check redemption, it may be checked against a personal identifier and other information that may be maintained by financial institution 102, 110, and/or clearing facility 112.

Clearing facility 112 uses the MICR information to pair payer and payee check images and then compares each pair of images to determine whether the images match. The images may be compared using any known image comparison technique. Additionally or alternatively, the MICR may be used to retrieve check layout information where such information is maintained by financial institution 102 for one or more types of checks that may be in the possession of payer 100. The check layout information may then be used to identify specific areas on the check in support of an area-by-area comparison between the images. If the check images do not match within a predefined tolerance, or if the personal identifiers described hereinabove do not match, then the check as submitted for redemption by payee 104 may be fraudulent and may be designated as invalid. Otherwise, if the check images match within a predefined tolerance, and if the personal identifiers described hereinabove match, the check as submitted for redemption may be designated as valid and may be honored.

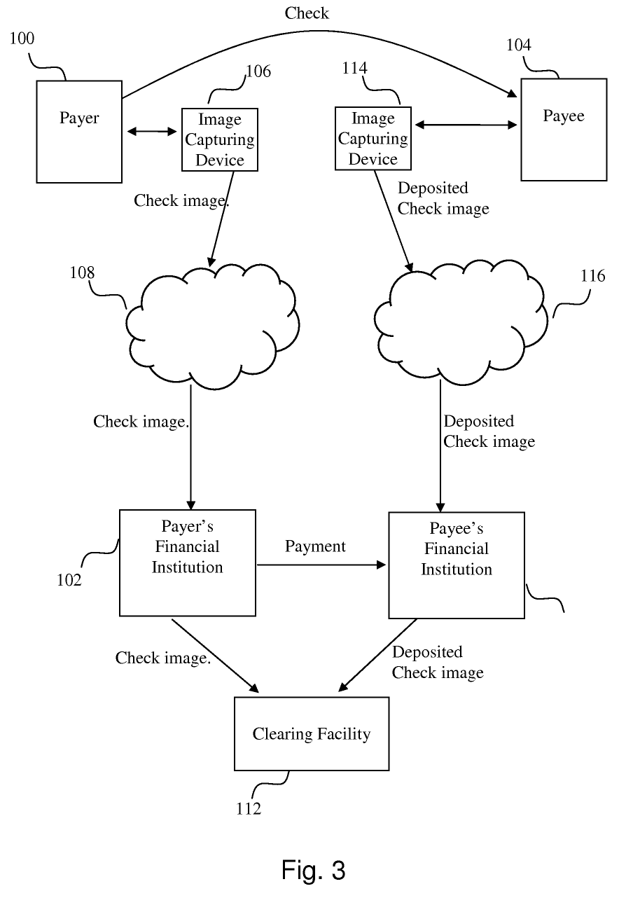

Reference is now made to the system of FIG. 3 which is a simplified conceptual illustration of a check validation system, constructed and operative in accordance with another embodiment of the present invention. The system of FIG. 3 is substantially similar to the system of FIG. 1 with the notable exception that upon receiving the check from payer 100, payee 104 captures the image of the check using an image capturing device 114, such as a cellular telephone camera, and sends the image by conventional means such as MMS 116 or via a network such as the Internet to financial institution 110 for redemption. Financial institution 110 may process the check image in a similar way to which it processes a check as described above.

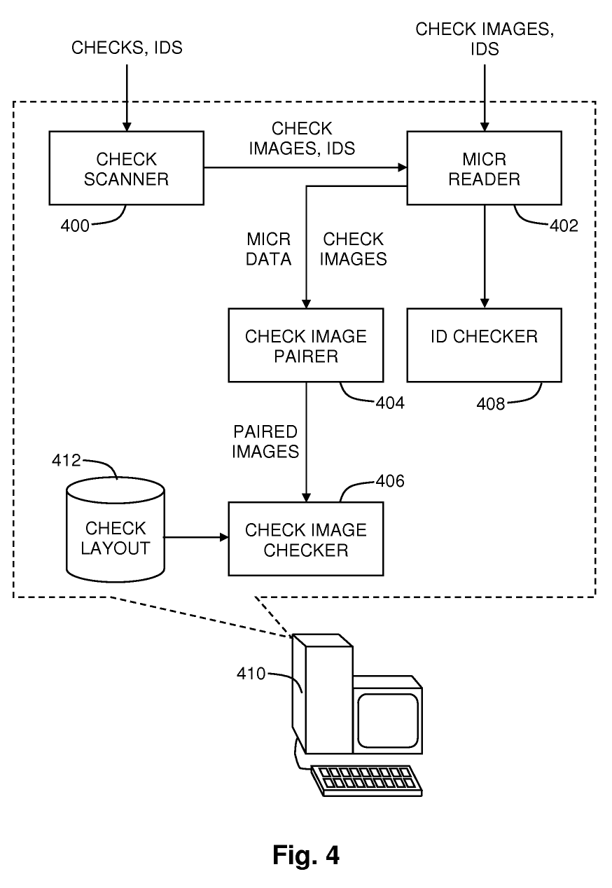

Reference is now made to FIG. 4, which is a simplified block diagram of a check image checking system, constructed and operative in accordance with an embodiment of the present invention. The system of FIG. 4 may be implemented by financial institution 102 and/or clearing facility 112 to carry out one or more aspects of the invention as described hereinabove. In the system of FIG. 4 a check scanner 400 produces scanned images of checks, such as when a payee provides a physical check when redeeming the check. A MICR reader 402 reads MICR data from received checks and/or check images as described hereinabove, which data are then used by a check image pairer 404 to pair check images received from payors with images of checks that are being redeemed by payees. MICR reader 402 may read the MICR data magnetically from the physical check itself and/or optically from either the physical check and/or its image. Paired images are then checked by a check image checker 406 to determine whether the check images match as described hereinabove, such as by utilizing check layout information stored in a storage 412. An identification checker 408 may check received personal identifiers against stored ones as described above.

Any of the elements of the invention described hereinabove may be embodied on a computer-readable medium and may be stored on, executed by, and/or otherwise managed by one or more computers 410.

It will be appreciated that by first storing an image of a payer's check along with the payer's personal identifier and then comparing it with the check or check image submitted for redemption, the present invention offers a higher degree of protection against fraud due to check theft, and counterfeit or altered checks. In addition, the present invention offers the payee a secure and convenient way to submit a check for redemption without having to physically bring it to a financial institution.

While the methods and apparatus herein may or may not have been described with reference to specific computer hardware or software, it is appreciated that the methods and apparatus described herein may be readily implemented in computer hardware or software using conventional techniques.

While the present invention described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A method for determining the validity of a check, the method comprising:
receiving from a payer an image of a check to a payee together with a personal identifier identifying said payer, wherein said payer is a customer of a financial institution;
determining an account to which said check pertains;
comparing said received personal identifier with a personal identifier maintained by said financial institution for said account;
comparing said payer check image with an image of said check produced after said payee receives said check from said payer;
designating said check as valid if said personal identifiers are the same and if said check images match within a predefined tolerance; and
designating said check as invalid if said personal identifiers are not the same or if said check images do not match within a predefined tolerance.

2. A method according to claim 1 wherein said receiving step comprises receiving said payer check image via a Multimedia Message Service.

3. A method according to claim 1 wherein said determining step comprises utilizing MICR data on said check to identify said account.

4. A method according to claim 1 wherein said comparing images step comprises utilizing MICR data on said images to pair said images for comparison where said MICR data on said images match.

5. A method according to claim 1 and further comprising maintaining check layout information for checks in the possession of said payer.

6. A method according to claim 5 and further comprising:
utilizing MICR data on said check to retrieve said check layout information of said check; and
identifying specific areas on said check in support of an area-by-area comparison between said images.

7. A method according to claim 1 and further comprising receiving a personal identifier identifying said payee, wherein said payee personal identifier is received together with said image of said check produced after said payee receives said check from said payer.

8-15. (canceled)
